(19) United States
(12) Patent Application Publication
(10) Pub. No.: US 2026/0219774 A1
(43) Pub. Date: Jul. 30, 2026

(54) DISPLAY SYSTEM AND DISPLAY METHOD

(71) Applicant: TOYOTA JIDOSHA KABUSHIKI KAISHA, Toyota-shi (JP)

(72) Inventor: Kazuho SAEKI, Kawasaki-shi (JP)

(73) Assignee: TOYOTA JIDOSHA KABUSHIKI KAISHA, Toyota-shi (JP)

(21) Appl. No.: 19/408,597

(22) Filed: Dec. 4, 2025

(30) Foreign Application Priority Data
Jan. 30, 2025 (JP) 2025-013468

(51) Int. Cl. G06F 3/04842

(52) U.S. Cl. CPC G06F 3/04842

(57) ABSTRACT

A display system according to the present disclosure includes an analysis object data acquisition unit, a feature acquisition unit, and a display control unit. The analysis object data acquisition unit acquires a plurality of pieces of analysis object data. The feature acquisition unit acquires a feature of the analysis object data. The display control unit displays at least one of the analysis object data and identification information of the analysis object data, arrayed in order of magnitude of the feature.

### CROSS-REFERENCE TO RELATED APPLICATION

This application claims priority to Japanese Patent Application No. 2025-013468 filed on January 30, 2025. The disclosure of the above-identified application, including the specification, drawings, and claims, is incorporated by reference herein in its entirety.

### BACKGROUND

### Technical Field

The present disclosure relates to a display system and a display method.

### Description of Related Art

Japanese Unexamined Patent Application Publication No. 2024-106786 (JP 2024-106786 A) describes an information processing device that executes principal component analysis with respect to measurement data of materials. The information processing device that is described in JP 2024-106786 A performs principal component analysis on a plurality of pieces of the measurement data, and thereby generates principal components of the measurement data, and principal component values of these principal components.

The information processing device that is described in JP 2024-106786 A displays the principal component values of each of a plurality of pieces of the measurement data generated on a display screen, and displays each of images representing the principal components of the multiple pieces of measurement data arrayed diagonally with respect to a horizontal direction or a vertical direction on the display screen.

The information processing device that is described in JP 2024-106786 A then displays, for each pair of a first image and a second image among each of the images representing the principal components of the multiple pieces of measurement data, a graph in which the principal component values of the multiple pieces of measurement data are plotted at a position representing intersection of a line extending in the vertical direction from the first image and a line extending in the horizontal direction from the second image.

### SUMMARY

Extracting features, such as principal component values, from data, is one of several effective means for analyzing the data. Here, in performing data analysis, it is important for a user to properly understand what sort of characteristics of the data the features that are extracted represent.

However, in the related art, it is difficult for the user to intuitively determine what sort of characteristics of the data that the features that are extracted represent. That is to say, there is a problem in the related art in that the features cannot be easily interpreted.

The present disclosure has been made to solve such problems, and an object thereof is to provide a display system and a display method that can facilitate interpretation of features.

A display system according to the present disclosure includes an analysis object data acquisition unit, a feature acquisition unit, and a display control unit. The analysis object data acquisition unit acquires a plurality of pieces of analysis object data. The feature acquisition unit acquires a feature of the analysis object data. The display control unit displays at least one of the analysis object data and identification information of the analysis object data, arrayed in order of magnitude of the feature.

This configuration enables the user to easily comprehend change in the analysis object data in accordance with change in the feature. As a result, the display system according to the present disclosure facilitates interpretation of feature.

In the display system according to the present disclosure, the display control unit may display the analysis object data arrayed in order of the magnitude of the feature.

The display system according to the present disclosure may further include an evaluation unit that evaluates difference in the feature between pieces of analysis object data that are adjacent in order of the magnitude of the feature. The display control unit may display a blank space between pieces of the analysis object data regarding which the evaluation unit evaluates the difference in the feature as being great.

In the display system according to the present disclosure, the display control unit may display, in a vicinity of a display region of the analysis object data, a selection image that enables selection of identification information of the feature. The display control unit may display the analysis object data arrayed in order of the magnitude of the feature that is selected, when a user selects the identification information of the feature in the selection image.

A display method according to the present disclosure includes the following processes.

Acquiring analysis object data.

Acquiring a feature of the analysis object data.

Displaying at least one of the analysis object data and identification information of the analysis object data, arrayed in order of magnitude of the feature.

The present disclosure can provide a display system and a display method that facilitate interpretation of features.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of an analysis system according to a first embodiment;

FIG. 2 is a block diagram illustrating a configuration of a server according to the first embodiment;

FIG. 3 is a block diagram illustrating a configuration of the server according to the first embodiment;

FIG. 4 is a schematic screen diagram for explaining a configuration of a display control unit according to the first embodiment; and

FIG. 5 is a flowchart showing operations of a display system according to the first embodiment.

### DETAILED DESCRIPTION OF EMBODIMENTS

### First Embodiment

### Configuration of Display System

A first embodiment according to the present disclosure will be described below in detail with reference to the drawings. First, a configuration of a display system according to the present embodiment will be described in detail.

The display system according to the present embodiment is a system that is configured as a part of an analysis system according to the present embodiment, and is a system for displaying analysis results of the analysis system according to the present embodiment to a user.

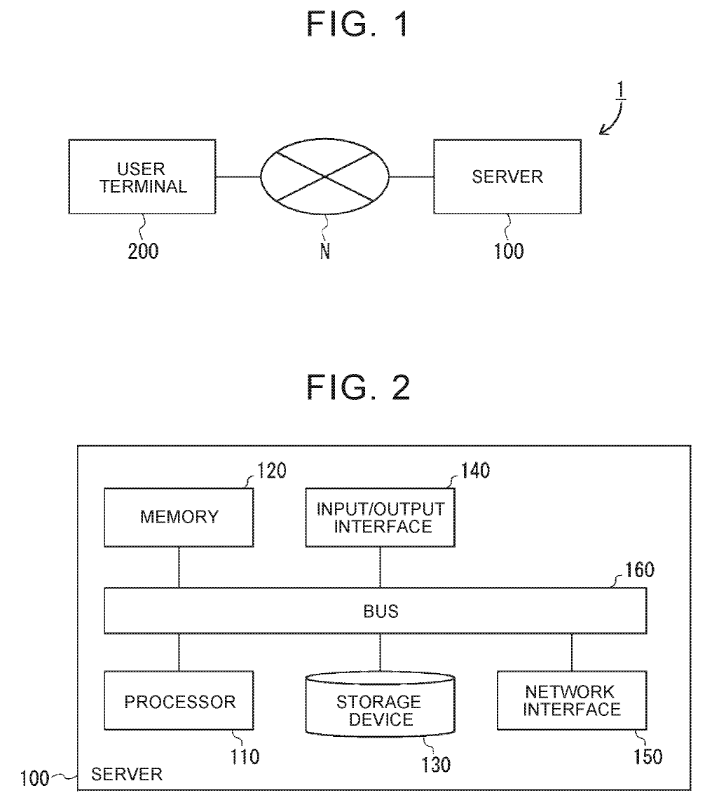

FIG. 1 is a block diagram illustrating a configuration of the analysis system according to the first embodiment. As illustrated in FIG. 1, in an analysis system 1 according to the present embodiment, a server 100 and a user terminal 200 are connected via a network N such as the Internet or the like.

The analysis system 1 is a system for analyzing analysis object data.

The analysis system 1 according to the present embodiment is typically provided as part of a data cloud service that is used in material development and research and development, and is used as a system for promoting research and development using so-called Materials Informatics (MI) and data science.

In this case, the analysis system 1 stores, for example, various types of measurement data of newly-developed materials. The analysis system 1 then uses as appropriate the measurement data that is stored, as analysis object data, based on instructions from the user.

In the analysis system 1, the user terminal 200 transmits analysis object data to the server 100, and the server 100 analyzes the analysis object data that is received. The server 100 then transmits analysis results to the user terminal 200, and the user terminal 200 displays the analysis results that are received.

Note that the analysis object data according to the present embodiment is not limited in particular, and may be any data that can be an object of principal component analysis.

Examples of analysis object analysis object data by the analysis system 1 include spectral data, waveform data, graph data, two-dimensional image data, three-dimensional image data, and so forth.

Examples of the spectral data include spectral data that is measured using nuclear magnetic resonance spectroscopy (NMR), infrared spectroscopy (IR), ultraviolet-visible spectroscopy (UV-vis), X-ray absorption spectroscopy (XAS), Raman spectroscopy, X-ray diffraction (XRD), small angle X-ray scattering (SAXS), mass spectrometry (MS), and so forth.

Also, examples of two-dimensional image data include image data taken using an optical microscope, a scanning electron microscope (SEM), a transmission electron microscope (TEM), computed tomography (CT), and so forth.

Further, examples of three-dimensional image data include photography data that is created by layering tomographic images that are taken by computed tomography (CT), model data that is created by computer-aided design (CAD) or the like, and so forth.

Examples of waveform data include time-series data, displacement data, and so forth. Examples of time-series data include acoustic data, vibration data, stock price trends, and so forth, but any data of which values change over time can be taken as an object. Examples of displacement data include surface height, surface profile, and so forth, of samples, but any data of which numerical values change with changes in coordinates and other parameters can be taken as an object.

Other examples of the data include cyclic voltammograms, chart graphs of gas chromatography (GC), and so forth.

Furthermore, coordinate data such as Crystallographic Information File (CIF) files or the like, or numerical data such as component lists of compositions or the like, can be used as the analysis object data, for example.

The user terminal 200 according to the present embodiment is a terminal that is operated by the user, and is typically a computer device having a display device.

The user terminal 200 transmits analysis object data to the server 100 via the network N. The user terminal 200 then receives the analysis results of the analysis object data from the server 100 via the network N.

The server 100 according to the present embodiment receives the analysis object data from the user terminal 200, and analyzes the analysis object data that is received. The server 100 then transmits the analysis results to the user terminal 200 via the network N.

FIG. 2 is a block diagram illustrating a hardware configuration of the server according to the first embodiment.

As illustrated in FIG. 2, the server 100 includes a processor 110, memory 120, a storage device 130, an input/output interface 140, a network interface 150, and an internal bus 160.

The internal bus 160 is a data transmission path through which the processor 110, the memory 120, the storage device 130, the input/output interface 140, and the network interface 150 exchange data with each other. Note, however, that the method of connecting the processor 110 and the like to each other is not limited to a bus connection.

The memory 120 is a main storage device that is realized using random access memory (RAM) or the like.

Also, the storage device 130 is an auxiliary storage device that is realized using a hard disk, a solid state drive (SSD), a memory card, read-only memory (ROM), or the like. The storage device 130 stores programs for realizing desired functions.

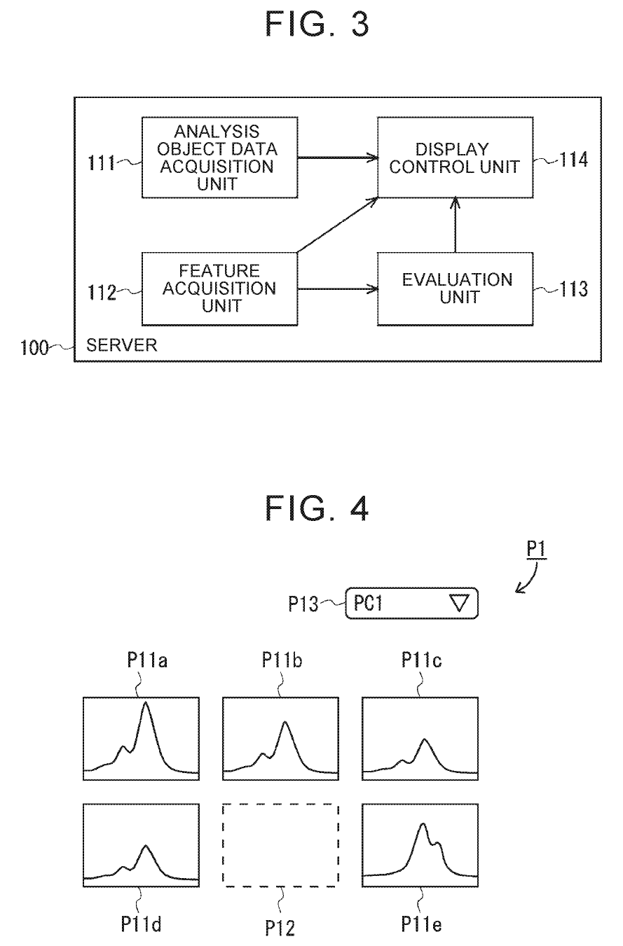

The processor 110 may be any of a variety of processors, such as a central processing unit (CPU), a graphics processing unit (GPU), a field-programmable gate array (FPGA), and so forth. The processor 110 reads out a program that is stored in the storage device 130 to the memory 120 and performs execution thereof, thereby executing functions of each of functional blocks illustrated in FIG. 3, which will be described later.

The input/output interface 140 is an interface for connecting the server 100 to an input/output device. For example, the input/output interface 140 may be connected to an input device such as a keyboard or the like, and an output device such as a display device or the like.

The network interface 150 is an interface for connecting the server 100 to the network.

Note that the program includes a set of instructions (or software code) for causing the computer to perform one or more functions that are described in the embodiments when the program is loaded to the computer. The program may be stored in non-transitory computer-readable media or tangible storage media. By way of example and not limitation, computer-readable media or tangible storage media include RAM, ROM, flash memory, an SSD or other memory technology, compact disc ROM (CD-ROM), digital versatile disc (DVD), Blu-ray (registered trademark) disc or some other optical disk storage, magnetic cassette, magnetic tape, magnetic disk storage or some other magnetic storage devices. The program may be transmitted on transitory computer-readable media or communication media. By way of example and not limitation, transitory computer-readable media or communication media include electrical, optical, acoustic, or other forms of propagated signals.

FIG. 3 is a block diagram illustrating functions of the server 100 according to the first embodiment.

As illustrated in FIG. 3, the server 100 according to the present embodiment includes an analysis object data acquisition unit 111, a feature acquisition unit 112, an evaluation unit 113, and a display control unit 114 as functional blocks.

The analysis object data acquisition unit 111 acquires a plurality of pieces of analysis object data. More specifically, the analysis object data acquisition unit 111 according to the present embodiment acquires the multiple pieces of analysis object data from the user terminal 200 via the network N. The analysis object data acquisition unit 111 outputs the multiple pieces of analysis object data acquired to the display control unit 114.

Note that the analysis object data acquisition unit 111 according to the present embodiment does not need to acquire the multiple pieces of analysis object data in a single reception.

For example, the analysis object data acquisition unit 111 according to the present embodiment may acquire the multiple pieces of analysis object data by acquiring analysis object data over several times.

In this case, the analysis object data acquisition unit 111 may store the analysis object data that is acquired in the storage device 130 each time analysis object data is acquired. When the analysis object data is to be displayed, the analysis object data that is the object of display may be read from the storage device 130 and output to the display control unit 114.

In this case, the analysis object data acquisition unit 111 does not need to read all of the analysis object data that is stored in the storage device 130, and may read just analysis object data that is specified by the user and perform output thereof to the display control unit 114.

That is to say, the analysis object data acquisition unit 111 may compile a database that stores the analysis object data. The analysis object data acquisition unit 111 according to the present embodiment may be configured such that the user can select data that is the object of display as appropriate from the database that is compiled.

The feature acquisition unit 112 acquires features of the analysis object data. The feature acquisition unit 112 outputs the features that are acquired to the evaluation unit 113 and the display control unit 114.

More specifically, the feature acquisition unit 112 acquires the features of each of the multiple pieces of analysis object data that are to be the object of display.

The feature acquisition unit 112 may acquire the analysis object data from the analysis object data acquisition unit 111, for example. The features of the analysis object data may then be acquired by extracting the features from the analysis object data that is acquired.

Also, the feature acquisition unit 112 may acquire the features that are recorded in association with the analysis object data from, for example, a database.

For example, the feature acquisition unit 112 according to the present embodiment may acquire a principal component value as a feature by performing principal component analysis (PCA) on multiple pieces of analysis object data.

Among the results that are acquired by analysis using features, it is particularly difficult for users to intuitively understand the principal components and the principal component values that are acquired by principal component analysis. Accordingly, the display system according to the present disclosure is particularly effective when the principal component values are used as features.

The evaluation unit 113 acquires, from the feature acquisition unit 112, features of the multiple pieces of analysis object data that are to be the object of display. The evaluation unit 113 evaluates differences in the features between pieces of analysis object data of which orders of magnitude of features are adjacent. The evaluation unit 113 outputs evaluation results of the difference in features to the display control unit 114.

More specifically, the evaluation unit 113 determines whether the magnitude of the difference in features between pieces of analysis object data, of which orders of magnitude of features are adjacent, is great.

For example, the evaluation unit 113 may perform evaluation that difference is great when the magnitude of the difference between the features is equal to or greater than a predetermined threshold value.

The evaluation unit 113 may also calculate an average value of the differences between the features. When the difference in the features to be an object of evaluation is greater than the average value that is calculated by a predetermined proportion, the evaluation unit 113 may evaluate the difference in these features to be great.

Also, the evaluation unit 113 may evaluate the difference in these features to be great when the magnitude of the difference in the features to be the object of evaluation is equal to or greater than a certain percentile from the bottom among a set of differences of features, for example.

Also, the evaluation unit 113 may perform clustering with respect to features of multiple pieces of analysis object data that is to be the object of display. The evaluation unit 113 may then evaluate difference in features corresponding to gaps between the clusters as a great difference, as a result of clustering.

That is to say, the method that is used by the evaluation unit 113 to evaluate the magnitude of the difference in features is not limited in particular, and any method may be used as long as appropriate evaluation can be performed.

Examples of methods for executing the aforementioned clustering include Gaussian mixture model (GMM), k-means clustering, density-based spatial clustering of applications with noise (DBSCAN), Variational Bayesian Gaussian Mixture Model (VB-GMM), and so forth.

The display control unit 114 acquires analysis object data from the analysis object data acquisition unit 111, acquires features from the feature acquisition unit 112, and acquires evaluation results of the magnitude of differences among the features from the evaluation unit 113. The display control unit 114 displays the analysis object data arrayed in order of the magnitude of the features. Furthermore, the display control unit 114 displays a blank space between pieces of analysis object data that are evaluated by the evaluation unit 113 as having a great difference in features.

FIG. 4 is a schematic screen diagram for explaining a configuration of the display control unit according to the first embodiment. More specifically, FIG. 4 is a schematic diagram illustrating an example of a configuration of a display screen that the display control unit 114 according to the present embodiment causes the user terminal 200 to display.

As illustrated in FIG. 4, five images P11a, P11b, P11c, P11d, and P11e, representing analysis object data, are displayed on a display screen P1 according to the present embodiment. Note that unless there is a particular need to distinguish between these five images, hereinafter they will be simply referred to as images P11.

Further, an identification image P13 is displayed on the display screen P1 according to the present embodiment. The identification image P13 is an image that is provided for the user to identify the type of feature, and is typically an image that displays the name of the feature in text.

The identification image P13 is configured to be switched as appropriate in response to a user operation. In other words, the identification image P13 according to the present embodiment has functions of a selection image that enables selection of identification information of features.

As described above, the display control unit 114 according to the present embodiment displays the analysis object data by arraying in order of the magnitude of the feature.

Now, observing the screen P1 that is illustrated in FIG. 4, the images P11a, P11b, P11c, P11d, and P11e are displayed in two rows, in the order illustrated therein. This indicates that the magnitude of the features is greater or smaller in the order of P11a, P11b, P11c, P11d, and P11e.

This configuration enables the user to easily comprehend change in the analysis object data in accordance with change in the feature. As a result, the display system according to the present embodiment facilitates easy interpretation of the features.

As described above, the display control unit 114 according to the present embodiment displays a blank space between pieces of analysis object data that are evaluated by the evaluation unit 113 when the difference in the features is great.

Here, observing the screen P1 illustrated in FIG. 4, a blank space P12 is displayed between the image P11d and the image P11e. This indicates that the evaluation unit 113 has evaluated that there is a great difference between the feature of the image P11d and the feature of the image P11e.

This configuration enables the user to even more easily comprehend the change in the analysis object data in response to the change in the features. As a result, the display system according to the present embodiment facilitates even easier interpretation of the features.

Also, the display control unit 114 according to the present embodiment displays a selection image that enables selection of identification information of features, in the vicinity of a display region of the analysis object data. When the user selects identification information of a feature in the selection image, the display control unit 114 displays the analysis object data arrayed in order of the magnitude of the feature that is selected.

Here, observing the screen P1 illustrated in FIG. 4, the identification image P13 is a text image that reads "PC1". This indicates that the images P11 are displayed arrayed in ascending order or descending order of the value of the feature having the name "PC1", i.e., the identification information.

This configuration enables operability of the display system according to the present embodiment to be improved.

It should be noted that, although the display system according to the present embodiment is configured to display the analysis object data arrayed in order of the magnitude of the feature, the configuration of the display system according to the present disclosure is not limited to this.

For example, the display system according to the present disclosure may display the identification information of the analysis object data arrayed in order of the magnitude of the feature. In this case, the display system according to the present disclosure may display, for example, the names of the analysis object data arrayed in order of the features thereof.

That is to say, at least one of the analysis object data according to the present disclosure and the identification information of the analysis object data may be displayed arrayed in order of the magnitude of the feature.

As described above, the display system according to the present embodiment displays the analysis object data arrayed in order of the magnitude of the features. This configuration enables the user to easily comprehend change in the analysis object data in accordance with change in the feature. As a result, the display system according to the present embodiment facilitates interpretation of the features.

### Operations of Display System

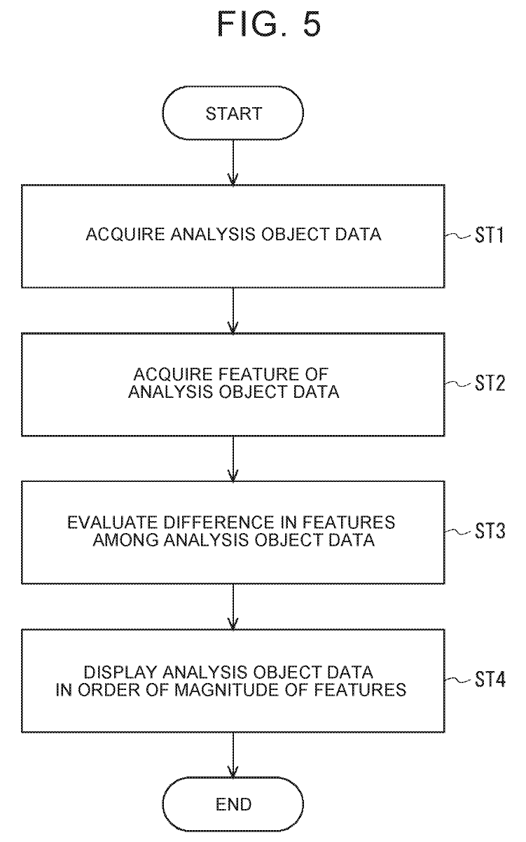

Next, the operations of the display system, i.e., the display method according to the first embodiment, will be described in detail. FIG. 5 is a flowchart showing operations of the display system according to the first embodiment. Note that in the following description, reference will be made to FIGS. 1 to 4 as appropriate.

In processing procedures of FIG. 5, the processor 110 that is provided in the server 100 functions as the analysis object data acquisition unit 111, the feature acquisition unit 112, the evaluation unit 113, and the display control unit 114, by reading a program that is stored in the storage device 130 to the memory 120 and performing execution thereof.

In the analysis method according to the present embodiment, first, the processor 110 acquires analysis object data (step ST1). That is to say, in step ST1, the processor 110 functions as the analysis object data acquisition unit 111.

Next, the processor 110 acquires the features of the analysis object data (step ST2). That is to say, in step ST2, the processor 110 functions as the feature acquisition unit 112. More specifically, in step ST2, the processor 110 acquires the features of the analysis object data that is to be the object of display.

Note that step ST2 may be a process in which the processor 110 acquires the features by extracting the features from a plurality of the pieces of measurement data. Alternatively, step ST2 may be a process in which the processor 110 acquires the features from a database that is stored in the storage device 130 or the like.

Next, the processor 110 evaluates differences in the features among the pieces of analysis object data (step ST3). That is to say, in step ST3, the processor 110 functions as the evaluation unit 113. More specifically, in step ST3, the processor 110 determines whether the magnitude of difference of the features between the pieces of analysis object data, which are adjacent in order of magnitude of the features, is great.

Finally, the processor 110 displays the analysis object data arrayed in order of features (step ST4), and the display system according to the present embodiment ends the series of operations. That is to say, in step ST4, the processor 110 functions as the display control unit 114.

More specifically, in step ST4, the processor 110 displays the analysis object data that is to be the object of display, arrayed in order of the magnitude of the feature that has been specified by the user.

Also, in step ST4, the processor 110 displays a blank space between pieces of the analysis object data that is evaluated as having great differences in the features.

As described above, in the display method according to the present embodiment, the analysis object data is displayed arrayed in order of the magnitude of features. This configuration enables the user to easily comprehend change in the analysis object data in accordance with change in the feature. As a result, the display method according to the present embodiment facilitates interpretation of features.

While the present disclosure has been described above by way of the embodiment, the present disclosure is not limited to the configuration of the embodiment that is described above alone, and it is needless to say that various modifications, alterations, and combinations that can be made by a person skilled in the art fall within the scope of the disclosure as defined in the claims of the present application.

What is claimed is:

1. A display system comprising:
an analysis object data acquisition unit that acquires a plurality of pieces of analysis object data;
a feature acquisition unit that acquires a feature of the analysis object data; and
a display control unit that displays at least one of the analysis object data and identification information of the analysis object data, arrayed in order of magnitude of the feature.

2. The display system according to claim 1, wherein the display control unit displays the analysis object data arrayed in order of the magnitude of the feature.

3. The display system according to claim 2, further comprising an evaluation unit that evaluates difference in the feature between pieces of analysis object data that are adjacent in order of the magnitude of the feature, wherein the display control unit displays a blank space between pieces of the analysis object data regarding which the evaluation unit evaluates the difference in the feature as being great.

4. The display system according to claim 1, wherein
the display control unit
displays, in a vicinity of a display region of the analysis object data, a selection image that enables selection of identification information of the feature, and
displays the analysis object data arrayed in order of the magnitude of the feature that is selected, when a user selects the identification information of the feature in the selection image.

5. A display method comprising:
acquiring a plurality of pieces of analysis object data;
acquiring a feature of the analysis object data; and
displaying at least one of the analysis object data and identification information of the analysis object data, arrayed in order of magnitude of the feature.
